(19) United States
(12) Patent Application Publication
(10) Pub. No.: US 2014/0021660 A1
(43) Pub. Date: Jan. 23, 2014

(54) METHOD FOR PRODUCING COMPONENTS BY MEANS OF POWDER INJECTION MOULDING, BASED ON THE USE OF ORGANIC YARNS OR FIBRES, ADVANTAGEOUSLY TOGETHER WITH THE USE OF SUPERCRITICAL CO2

(71) Applicant: Commissariat A L'Energie Atomique Et Aux Energies Alternatives, Paris (FR)

(72) Inventors: Luc Federzoni, Bourgoin-Jallieu (FR); Pascal Revirand, Saint Egreve (FR)

(73) Assignee: Commissariat A L'Energie Atomique Et Aux Energies Alternatives, Paris (FR)

(21) Appl. No.: 14/033,856

(22) Filed: Sep. 23, 2013

Related U.S. Application Data
(63) Continuation of application No. PCT/FR2012/050465, filed on Mar. 7, 2012.

(30) Foreign Application Priority Data
Apr. 13, 2011 (FR) 11.53207

(51) Int. Cl. C08K 5/01; C08K 3/22; B29C 45/00

(52) U.S. Cl. CPC C08K 5/01; B29C 45/0001; C08K 3/22
USPC 264/645; 524/430

(57) ABSTRACT

The invention relates to a feedstock for power injection molding, PIM, comprising: at least one inorganic powder, advantageously metallic or ceramic or made of cermet; a polymeric binder; organic fibres or yarns, advantageously polymeric, the fibres or yarns being made of a material different from that of the polymeric binder. It then relates to the method for producing such a feedstock, as well as the method for producing parts by means of the powder injection moulding (PIM) technique using said feedstock.

### FIELD OF THE INVENTION

The present invention relates to a method for manufacturing parts, and especially bulky parts (on the order of 10 cm³) having a complex shape, by means of power injection molding or PIM techniques, using so-called hybrid feedstocks containing organic fibres or yarns.

The used organic fibres or yarns are advantageously polymeric, for example, made of polyamide, polyester, or polypropylene (PP).

The presence of such micro- or nanofibres or yarns in the initial feedstock favors the mechanical behavior of the parts during the PIM process. Such fibres or yarns are suppressed by debinding at the end of the process, advantageously after the removal of the polymeric binder.

The use of such fibres or yarns enables to manufacture large parts, which normally cannot be formed by the PIM process. The forming of such parts is further favored by the use of a supercritical fluid in the debinding step.

The components manufactured by means of the method according to the invention provide remarkable properties at all manufacturing steps:
the injected parts have an improved mechanical behavior, and this, due to the fibres/yarns, which have a composite effect;
the debound parts have an improved mechanical resistance, due to the fibres/yarns remaining after removal of the binder.

### BACKGROUND

The use of fibres or yarns as additives in plastics engineering (polymer manufacturing industry) is known in many industrial applications such as the automobile, aeronautical, and medical fields. The resulting materials, formed of fibres embedded in a polymer matrix, are called polymer-matrix composites.

Such materials more generally have the following properties, which derive from the addition of fibres:
mechanical strengthening;
shock absorption;
high elastic moduli;
fire retardant.

In this context, and more generally, the added fibre is a glass polyaramid (Kevlar®), carbon, or aramid fibre.

Further, the PIM process is currently used to manufacture small metal or ceramic components. Generally, the parts are rather small (bulk of a few cm³) and have a complex shape, since it is a replication process. Further, the debinding of 3D parts with thick walls is very difficult since the removal of inorganic matter from the part to be debound has to be managed.

In practice, PIM is a method which however has a number of disadvantages, which current appear as inseparable from this technology. It has the following recurrent defects:
the parts are quite brittle when green, that is, just after injection, and even more so when debound;
the parts are always small. It is considered by those skilled in the art that the method does not enable to manufacture parts of more than 10 cm³.

The brittleness of injection and debound PIM parts is a recurrent concern, which has been the object of many recent publications, such as document EP 1972419. These problems however have no real technical solution to date.

In this technical field, the use of fibres or yarns in PIM feedstocks to manufacture metal matrix composites (MMC) has already been mentioned in the past. The fibre is then only used to strengthen the final product, as is the case in MMCs. Thus, and in all cases, fibres have no interest for intermediate steps, especially at the debinding step, and are only used to provide specific properties, generally mechanical, to the final component which is thus formed of fibres embedded in the matrix.

A very thorough description of the state of the art in relation with the MIM (Metal Injection Molding) technique is provided in the following article: Hezhou Ye, Xing Yang Liu, Hanpring Hong, Journal of Materials processing Technology 200 (2008) 12-24.

Further, in already-described PIM processes and to eliminate the polymeric binder, it has been provided to perform the debinding step by means of a super-critical fluid, especially supercritical CO₂.

The supercritical CO₂ technology is based on the dissolving power of CO, which is adaptable at will according to the applied pressure and temperature conditions.

In the supercritical state (in conditions of pressure greater than 74 bars and of temperature greater than 31° C.), CO₂ has very specific properties. Indeed, the obtained fluid is characterized by a high diffusivity (on the order of that of the gases) which gives it a good ability to diffuse, and by a high density which gives it a significant transport and extraction capacity.

Such characteristics make it particularly advantageous for the debinding of PIM parts. Indeed, it high capacity of diffusing enables to envisage penetrating PIM parts to the core and its capacity of extracting the binder enables to envisage short debinding treatment times. The CO₂ debinding technique is known and currently marketed. As an example, company “Applied Separations” sells equipment accessible on the following link:

http://www.appliedseperations.com/supercritical/mim/default.asp

However, to date, the process does not enable to debind large parts, the extraction of the polymers forming the binder always bringing about risks of cracking on large parts. Further, the selection of the polymers is extremely important since they should be solvatable by supercritical CO₂, which is generally not the case.

Document Yong-Ho Kim, Youn-Woo Lee, Jong-Ku Park, Chang-Ha Lee, Jong Sung Lim, Korean J. Chem. Eng., 19(6) (2002) 986-991 discloses such a debinding technique. Most often, only polymers with a short chain are extractible by this technique. Now, in the case of MIM, this is very prejudicial since these same short chains result in very low green mechanical behaviors. Thereby, such a debinding technique is currently only used for microparts.

There thus is an obvious need for the developing of new technical solutions enabling to avoid the pitfalls mentioned hereabove in relation with the PIM technology, and especially enabling to manufacture large parts.

### SUMMARY OF THE INVENTION

The present invention provides a new generation of feedstock, based on the use of organic fibres or yams as additives in the feedstock.

The use of such fibres or yams provides the following technical advantages:
certain mechanical and physical properties of the final product may be intensified;
the filler content (quantity of powders and of fibres or yarns introduced into the mixture) may be increased with respect to conventional solutions;
it is possible to manufacture large parts (of several liters, that is, at least 10 times larger than with the standard technology).

As a feature of the invention, the fibres or yarns incorporated in the feedstock are not present in the final material. Thus, the fibre is not inserted with a view to forming a composite material.

Conversely, and according to the invention, the fibre is only incorporated in the feedstock to provide an ephemeral function in order to improve the PIM process. Thus, the fibre as such disappears from the final product, by degradation, advantageously during a thermal debinding after the removal of the polymeric binder.

A feedstock adapted for the implementation of the present invention thus comprises:
an inorganic powder, advantageously metallic or ceramic or made of cermet;
one or more addition polymers behaving as a plasticizer, lubricant, and/or surfactant;
fibres or yams, of micronic or nanometric diameter, respectively. Such fibres are of organic nature, advantageously made of polymer. The fibres may be short or long.

In other words, the present invention relates to a feedstock intended to be used in the PIM power injection molding technique, which comprises:
at least one inorganic powder, advantageously metallic or ceramic or made of cermet;
a polymeric binder;
organic fibres or yams, advantageously polymeric.

Advantageously, the fibres or yarns and the binder are not made of the same material. Indeed, and as will be detailed hereafter, they are preferably successively and differentially eliminated during the debinding.

As known, the feedstock thus comprises at least one inorganic powder and a polymeric binder.

The inorganic powder according to the invention may be a powder made of a single material, of several materials, or a mixture of powders.

Advantageously, it is a metal or ceramic or cermet powder. It may for example be an alumina powder.

Although the powder is generally micronic, the use of nanometric powder(s) can be envisaged. Further, mixtures of powders (micronic and/or nanometric) are also targeted by the invention.

It should be noted that the powder may be treated by means of a surfactant, such as for example stearic acid. This enables to lower the necessary surfactant rate in the polymeric binder.

Conventionally, the feedstock according to the invention also comprises a polymeric binder, intended to be eliminated during the debinding step. Advantageously, it comprises one or several addition polymers behaving as a plasticizer, lubricant, and/or surfactant. These advantageously are short-chain non-polar polymers, advantageously of molecular weight lower than 1,500 g/mol, and preferably a paraffin wax.

Typically according to the invention, the feedstock further comprises organic fibres or yarns, advantageously of micronic or even nanometric diameter.

In the context of the invention, “fibres” advantageously designates very slender particles. The “wires” correspond to specific fibres, crossing the sample. These may be short or long fibres, of dimensions ranging from a few millimeters to a few centimeters (for example, 3 cm).

As already mentioned, these fibres or yarns are organic, advantageously made of polymer.

In the context of the invention, the fibres are incorporated to increase the mechanical properties of green parts (that is, just after injection) and debound parts (brown). The use of such fibres enables to avoid the use of plasticizing polymers having significant mechanical properties and also significant viscosities during the injection phase (which limits the filler content): The fibres enhance the mechanical properties of the parts, as in the case of polymer matrix fibre composites.

Advantageously according to the invention, the fibres or yarns are not formed by means of conventional materials of reinforcement fibres, and especially carbon, Kevlar, or aramid.

According to a preferred embodiment and as detailed hereafter, these fibres or yarns should be eliminated during the debinding, advantageously by thermal debinding. The material forming the organic fibres or yarns should thus be capable of degrading during a thermal treatment, advantageously carried out at a temperature ranging between 300° C. and 800° C.

Fibers or yarns fulfilling these conditions are advantageously made of polyamide, of polyester, or of polypropylene (PP).

As already mentioned, the relative nature relative of the fibres or yarns with respect to the polymeric binder is important. Indeed, and in privileged fashion, the fibres or yarns are formed by means of a material different from that of the polymeric binder. It is thus possible to differentially and successively eliminate the binder and the fibres or yarns during the debinding step.

Further, and as will be seen hereafter, the fibres or yarns are advantageously preserved from the extraction by means of a supercritical fluid such as CO₂. Preferably, the fibres or yarns are thus made of a material non solvatable by a supercritical fluid, and advantageously non solvatable by supercritical CO₂, which is true for polyamide, polyester, and polypropylene.

According to another aspect, the invention relates to a method for manufacturing a feedstock such as defined hereabove, which comprises the steps of:
preparing the polymeric binder by incorporation and mixture of the polymers forming the binder;
incorporating the organic fibres or yarns;
incorporating the inorganic powder(s).

The last two steps may be inverted, that is, the inorganic powder(s) may be incorporated before the organic fibres or yarns.

The manufacturing of such a feedstock is advantageously performed in a kneader, to ascertain that a homogenous mixture is obtained. Further, it is advantageously performed under heating, at a temperature which however does not cause the degradation of the material forming the binder and the fibres or yarns. In practice, it is advantageously performed at a temperature lower than or equal to 100° C.

The powder and the fibres or yarns are added by an adapted quantity until the desired filler value (volume filler content), typically ranging between 50 and 70%, is reached. The quasi-exclusive use of paraffin as a binder enables to very significantly increase the filler content with respect to conventional formulations with no fibres or yarns.

The relative proportion of the powders and of the fibres or yams is a compromise between a filler content (the largest possible) and the mechanical behavior of green parts (the highest possible):
increasing the powder results in increasing the filler content;
increasing the fibres results in better mechanical behaviors of green parts.

According to another aspect, the invention also aims at a method for manufacturing parts by the power injection molding technique (PIM), which comprises the steps of:
preparing a feedstock such as defined hereabove;
injecting the feedstock into the mould;
debinding, to eliminate the polymeric binder and the fibres or yarns;
sintering.

Advantageously according to the invention:
the debinding is carried out in 2 steps, with a successive removal of the polymeric binder and of the fibres or yarns;
the polymeric binder is eliminated first, before the fibres or yarns;
the polymeric binder is eliminated by chemical debinding, advantageously by supercritical fluid, more advantageously still by supercritical CO₂;
the fibres or yarns are eliminated by thermal debinding.

The feedstock is advantageously prepared as described hereabove.

According to a preferred embodiment, the feedstock thus prepared is cooled and granulated, advantageously by means of a granulator. It is then used as a raw material for the injection.

The injection into an adapted mould is performed conventionally, advantageously under pressure. Typically, the granules are heated in the injection screw and then injected in a matrix.

According to a first embodiment, the binder and the fibres or yarns, although formed of different materials, are eliminated by a same debinding method, for example, by thermal debinding at a temperature enabling to eliminate both materials.

As a variation and according to a preferred embodiment, after injection, during the first debinding step, the binder polymers are extracted so that they can no longer be found in the part after this debinding step.

Advantageously, this extraction is performed by means of the technique of debinding under supercritical fluid, more advantageously still under supercritical CO₂. A conventional chemical debinding may also be suitable, especially in the presence of hexane or water (in the case of PEG of low molecular weight). A thermal debinding at a temperature which does not affect the organic fibres or yarns can also be envisaged.

In this case, due to the presence of the remaining fibres or yarns, it is thus possible to apply the debinding under supercritical fluid, advantageously under supercritical CO₂, including on large parts.

Indeed, the incorporated fibres or yarns, present at the injection step and on debinding, enable to improve the mechanical properties of green parts (that is, just after injection) and debound parts (brown).

Thus, the implementation of the method according to the invention enables to form large parts with the PIM technology. Indeed, the presence of fibres enables to maintain the assembly of powder grains which form the future part, without for said part to collapse (composite effect).

Generally, and as already mentioned, during this first debinding step, the binder polymers should be extracted without altering the fibres or yarns of the matrix forming the part, said fibres or yarns being only eliminated during the second debinding step.

Several combinations of successive differential debindings can be envisaged, and especially:
a fibre thermally debound at high temperature, while the polymeric binder is degraded at low temperature. Such is for example the case for an association of PA fibres and of a paraffin wax matrix: The PA fibres are degraded by oxidation at high temperature in a second temperature stage, while during the first temperature stage, the wax matrix is degraded;
a matrix chemically debound during a debinding while the fibres are degraded subsequently by thermal debinding.

As already mentioned, the fibres or yarns advantageously have a thermal debinding degradation temperature approximately ranging from 300 to 800° C. Thus, during the chemical debinding step enabling to eliminate the polymeric binder in presence, the fibres remain in the mixture. Thereby, brown parts have significant mechanical properties. The fibres will then be degraded in a subsequent thermal debinding step, preceding the sintering, which may also be called pre-sintering. This step is carried out in conditions enabling to degrade the fibres or yarns, and thus typically at a temperature ranging from 300 to 800° C. At the end of the process, there is no trace of presence of these fibres or yarns on the final parts.

In this case, the fibres or yarns have two functions:
providing a larger filler content by the partial replacing of the plasticizer;
providing significant mechanical properties.

The next step is the sintering, which step is conventionally carried out at a temperature determined by the nature of the sintering materials, generally on the order of 0.7 times the melting temperature of the material to be sintered. The sintering normally lasts for at least 1 hour.

The method according to the invention enables to obtain parts with unique properties, and especially:
a large bulk, advantageously a volume greater than 10 cm³, or even greater than or equal to 100 cm³;
improved mechanical properties;
due to the greater filler contents, a better control of the geometric dimensions of the parts (less shrinkage).

The advantages of the present invention will better appear from the following embodiment.

### EXAMPLE OF EMBODIMENT

The following non-limiting embodiment aims at illustrating the invention. This example concerns the forming of a feedstock based on polypropylene (PP) fibres for the forming of alumina components.

The feedstock has the following formulation, expressed in % by mass:
paraffin wax (of the type sold by Sasol): 44%;
alumina powder (particle size on the order of one micron): 52%;
polypropylene fibre (supplier: Barnett): 2%;
stearic acid 2%.

In this example, the PP fibre is used as a plasticizer.

It is important for the feedstock to be formed at a temperature such that it does not cause the degradation of the material forming the fibres, in the case in point, PP. The mixture is thus performed at 100° C. At this temperature, the fibre remains intact. The forming of the feedstock results in the forming of a mixture formed of PP fibres, of a paraffin matrix, and of a dispersion of alumina powder.

In this example, the debinding is performed by extraction under supercritical CO₂. This technique extracts all the paraffin without affecting the matrix PP fibres. A whole part, capable of being manipulated, is thus kept.

During the thermal debinding step, the PP is eliminated by oxidation, as in any thermal debinding.

After, the part is conventionally sintered at 1,700° C. for 2 hours.

1. A feedstock for power injection molding, comprising:
at least one inorganic powder, advantageously metallic or ceramic or made of cermet;
a polymeric binder;
organic fibres or yarns, advantageously polymeric, the fibres or yarns being made of a material different from that of the polymeric hinder.

2. The feedstock of claim 1, wherein the fibres or yarns are made of a material capable of being degraded by thermal treatment, advantageously at a temperature ranging between 300° C. and 800° C.

3. The feedstock of claim 1, wherein the fibres or yarns are made of a material which is not solvatable by a supercritical fluid, and especially by supercritical CO₂.

4. The feedstock of claim 1, wherein the fibres or yarns are made of polyamide, polyester, or polypropylene (PP).

5. The feedstock of claim 1, wherein the polymeric binder is made of non-polar polymers of low molecular weight, advantageously of paraffin wax.

6. A method for manufacturing the feedstock of claim 1, comprising the steps of:
preparing the polymeric binder by incorporation and mixture of the polymer(s) forming the binder;
incorporating the organic fibres or yarns;
incorporating the inorganic powder(s).

7. The feedstock manufacturing method of claim 6, wherein the method is carried out under heating, at a temperature which however does not cause the degradation of the material of the fibres or yarns, advantageously at a temperature lower than or equal to 100° C.

8. The feedstock manufacturing method of claim 6, wherein the volume tiller content of powders and fibres or yarns ranges between 50% and 70%.

9. A method for manufacturing parts by the power injection molding technique (PIM), comprising the steps of:
preparing the feedstock of claim 1,
injecting the feedstock into the mould;
debinding, to eliminate the polymeric binder and the fibres or yarns;
sintering.

10. The method for manufacturing parts of claim 9, wherein the debinding enables to successively eliminate the polymeric binder and the fibres or yarns.

11. The method for manufacturing parts of claim 10, wherein the debinding enables, first, to eliminate the polymeric hinder, and then the fibres or yarns.

12. The method for manufacturing parts of claim 9, wherein the polymeric binder is debound by means of a supercritical fluid, advantageously supercritical CO₂.

13. The method for manufacturing parts of claim 10, wherein the polymeric binder is debound by means of a supercritical fluid, advantageously supercritical CO₂.

14. The method for manufacturing parts of claim 9, wherein the fibres or yarns are debound by thermal treatment, advantageously carried out at a temperature ranging between 300 and 800° C.

15. The method for manufacturing parts of claim 10, wherein the fibres or yarns are debound by thermal treatment, advantageously carried out at a temperature ranging between 300 and 800° C.

16. The method for manufacturing parts of claim 9, wherein the sintering is carried out at a temperature on the order of 0.7 times the melting temperature of the materials to be sintered.

17. The method for manufacturing parts of claim 10, wherein the sintering is carried out at a temperature on the order of 0.7 times the melting temperature of the materials to be sintered.
